(19) United States
(12) Patent Application Publication
(10) Pub. No.: US 2013/0098735 A1
(43) Pub. Date: Apr. 25, 2013

(54) ENHANCED METHODS FOR SOLVENT DEASPHALTING OF HYDROCARBONS

(71) Applicants: TOM CORSCADDEN, Calgary (CA); GERALD BRUCE, Calgary (CA); GREG DIDUCH, Calgary (CA); DAMIEN HOCKING, Calgary (CA); DARIUS REMESAT, Calgary (CA)

(72) Inventors: TOM CORSCADDEN, Calgary (CA); GERALD BRUCE, Calgary (CA); GREG DIDUCH, Calgary (CA); DAMIEN HOCKING, Calgary (CA); DARIUS REMESAT, Calgary (CA)

(73) Assignee: MEG ENERGY CORP., Calgary (CA)

(21) Appl. No.: 13/566,493

(22) Filed: Aug. 3, 2012

Related U.S. Application Data
(60) Provisional application No. 61/548,915, filed on Oct. 19, 2011.

(51) Int. Cl. B01D 11/04; C10G 57/00; C10C 3/16

(52) U.S. Cl. 196/14.52; 208/309; 208/95

(57) ABSTRACT

Improvements to open-art Solvent Deasphalting (SDA) processes have been developed to reduce capital and operating costs for processing hydrocarbon streams are provided whereby open art SDA scheme is modified to include appropriately placed mixing-enabled precipitators (MEP's) to reduce solvent use requirements in an asphaltene separation step and to increase overall reliability for SDA processes, particularly suitable for Canadian Bitumen. When integrated with a mild thermal cracker, the improved SDA configuration further improves crude yield to be pipeline-ready without additional diluent and for use to debottleneck existing facilities such as residue hydrocrackers and coking units.

This application claims the benefit of U.S. provisional patent application No. 61/548,915 filed Oct. 19, 2011.

### FIELD OF THE INVENTION

This invention has to do with improving produced bitumen, focusing on (but not limited to) Canadian bitumen, by a novel post-production process improving deasphalting in particular.

### DESCRIPTION OF PRIOR ART

### Prior Art SDA Schemes:

Solvent Deasphalting (“SDA”) is a process employed in oil refineries to extract valuable components from residual oil from a prior operation. The extracted components can be further processed in refineries where they are cracked and converted into valuable lighter fractions, such as gasoline and diesel. Suitable residual oil feedstocks which can be used in solvent deasphalting processes include, for example, atmospheric tower bottoms, vacuum tower bottoms, crude oil, topped crude oils, coal oil extract, shale oils, and oils recovered from oil sands.

Solvent Deasphalting processes are well known and described, with many in the open-art, for instance, in Smith's U.S. Pat. No. 2,850,431, Van Pool's U.S. Pat. No. 3,318,804, King et al's U.S. Pat. No. 3,516,928, Somekh et al's U.S. Pat. No. 3,714,033, Kosseim et al's U.S. Pat. No. 3,714,034, Yan's U.S. Pat. No. 3,968,023, Beavon's U.S. Pat. No. 4,017,383, Bushnell et al's U.S. Pat. No. 4,125,458, and Vidueira et al's U.S. Pat. No. 4,260,476 all of which would benefit from further energy saving and performance enhancing features that could reduce solvent to oil ratio and/or improve recovery of desired hydrocarbon products.

### Treatment of SDA Generated Asphaltene-Rich Streams in the Prior Art:

In U.S. Pat. No. 4,421,639 a SDA process uses a 2^{nd} asphalt extractor to concentrate asphaltene material (and recover more deasphalted oil). A concentrated asphalt stream with added solvent is sent through a heater which raises the stream's temperature to 425° F. at 18 psia, and is then sent to a flash drum and steam stripper to separate solvent (in this case propane) from the asphalt stream. Asphalt product in liquid form is pumped to storage. This arrangement only works if the asphalt rich stream is liquid at these conditions. It is burdened by plugging if any appreciable solid asphaltenes are present as in asphaltene-rich streams like bitumen, and the process has a high solvent requirement.

In U.S. Pat. No. 3,847,751, concentrated asphaltenes produced from an SDA unit are mixed with solvent and transported as a liquid solution into a spray dryer. The spray nozzle design and pressure drop in the dryer determines the size of liquid droplets that are formed. The smaller the light hydrocarbon (solvent) droplet, the faster it will flash completely to vapour. The smaller the heavy hydrocarbon (asphaltene) particle the more surface area per volume/mass available for heat transfer by radiation and conduction to cool the heavy droplets. The goal in the dryer is to produce dry, non-sticky solid asphaltene particles. Cold gas is added to the bottom of the spray dryer to enhance cooling by additional convective and conductive heat transfer as well as increasing droplet residence time by slowing droplet descent rate (via upward cooling gas flow) in order to reduce the size of the vessel (which tend to be extremely large). This arrangement is not feasible if the asphaltene particles that have settled out in the extractor are in a solid form in the solvent at the process operating temperature. Solid particles plug the spray drier nozzle limiting reliability and thus viability of this scheme in solid asphaltene rich streams.

In U.S. Pat. No. 4,278,529, a process for separating a solvent from a bituminous material by pressure reduction without carry-over of bituminous material is disclosed. A feedstock in a fluid-like phase comprising bituminous material and solvent undergoes a pressure reduction process by passage through a pressure reduction valve and is then introduced into a steam stripper. The pressure reduction process vaporizes part of the solvent and also disperses a mist of fine bituminous particles in the solvent. The remaining asphaltene remains wet and sticky and has not enough solvent left to keep the heavy bituminous phase (with many solids) fluid.

U.S. Pat. No. 4,572,781 discloses a SDA process for separating substantially dry asphaltenes of high softening point (temperature) from heavy hydrocarbon material using a centrifugal decanter to separate a liquid phase from a highly concentrated slurry of solid asphaltenes. This process is designed to handle a rich asphaltene stream that has solid particles but is a highly costly process since the separation of the solids is done through a solid/liquid separation with additional solvent needed to make the material flow to the decanter. The solid material is still relatively wet once separated and needs a further drying step to recover solvent as a vapour. The recovered solvent vapour then needs to be condensed for re-use, which is another high energy step adding complexity.

In U.S. Pat. No. 7,597,794, a dispersion solvent is introduced into am asphalt stream after separation by solvent extraction and the resulting asphalt solution undergoes rapid change in a gas-solid separator and is dispersed into solid particles and solvent vapor, resulting in low temperature separation of asphalt and solvent with adjustable size of the asphalt particles. The challenge with flash/spray driers such as disclosed here using liquid solvent as a transport media is the propensity for the asphaltenes generated in the integrated process to remain wetted before, during and after a flash drying phase. In addition, with this integrated process, the asphaltene continues to liquefy at elevated temperatures. Wetted asphaltene sticks to surfaces and fouls and plugs process equipment. The reduced reliability inherent in this approach makes such operations costly for heavy crudes with high asphaltenic content.

In U.S. Pat. No. 7,964,090 a method for upgrading heavy asphaltenic crudes using SDA and gasification is disclosed. A stream to a gasifier is generated by mixing hydrocarbons comprising one or more asphaltenes and one or more non-asphaltenes with a solvent, wherein the ratio of solvent to hydrocarbon is from about 2:1 to about 10:1. The resulting asphaltene rich stream is transferred out of the SDA to a gasifier as a liquid. The large quantities of solvent used in transport are consumed in the gasifier and downgraded in value to a fuel gas equivalent. Since the asphaltenes tend to be liquid, using a solvent to transport the material in the quantities stated is feasible. For a solid asphaltene, this method would require 10-20 times more solvent for transport and the high quantity of expensive solvent would be consumed in the process and its value reduced.

In U.S. Pat. No. 4,572,781, a process for separating substantially dry asphaltenes from heavy hydrocarbon material using solvents is disclosed. Two stages of liquid extraction (decanters) to produce a DAO product followed by screw conveyance of asphaltene slurry, and two stages of solid-vapour separation in a spray drier and separator to generate dry asphaltenes form the scope of the patent. The patent is instructive and educational in that the concept of generating a dry asphaltene by-product is feasible in the DAO production process. However, the process is burdened by the many required process steps to get both the DAO product and the dry asphaltene product. In addition, the operating conditions required to generate the solid asphaltenes in the decanting step do not work for Canadian bitumen. At conditions sited in the patent, (<150° C.), Canadian bitumen, whether thermally converted or separated in an upstream fractionator, will not flow and will plug the system. In an alternate embodiment, U.S. Pat. No. '781 replaces the spray drier with an evaporator and adds water/surfactant to the process to assist in separating the solvent. No savings in processing steps are made and an additional material is added increasing the complexity of operation.

### SPA Schemes in Refining and Upgrading in the Prior Art:

In U.S. Pat. No. 7,749,378, a ROSE (Residual Oil Supercritical Extraction) SDA process is applied to an atmospheric residue or vacuum bottoms residue stream within a refinery or Upgrader. The separated asphaltene-rich stream from the ROSE SDA unit is a liquid solution which is very sticky and requires extreme operating conditions (high temperatures) and added solvent to facilitate feedstock flow through the process equipment which is very intensive and expensive. This process does not put the solid asphaltenes through a mild thermal cracking process, and thus does not convert the asphaltenes from a sticky to a crunchy texture, and relies primarily on excess solvent to transport the asphaltene stream in a diluted form.

The targeted embodiment of the ROSE SDA process disclosed requires at least a 4:1 solvent to oil (residue) ratio (by mass) and operating temperatures of the extractor in the range of 300-400° F. In practice, the temperature must be even higher or the solvent flow must be increased in order to keep the asphaltene-rich stream from plugging the process. In this set up, a large portion of the original feedstock is downgraded from crude and sent to a low conversion (i.e. coker, gasification) or low value operation (asphalt plant) reducing the overall economic yield of the crude (in addition to the relatively high process intensity of the operation).

### The Desirability of Integrated Hydrocarbon Cracking and SDA Schemes:

Processes have been disclosed to convert and/or condition heavy hydrocarbon streams (for instance Oil Sands bitumen) into pipeline transportable and refinery acceptable crude. Of note, thermal cracking, catalytic cracking, solvent deasphalting and combinations of all three (for example, visbreaking and solvent deasphalting) have been proposed to convert bitumen to improve its characteristics for transport and use as a refinery feedstock.

The benefits of the invention disclosed below may be understood in the context of the operation of the thermal cracking unit noted in U.S. Pat. No. 7,976,695 and an example generated by integrating operation of that ('695) thermal cracker with an SDA in U.S. patent application Ser. No. 13/037,185.

Figure A shows the arrangement of two types of asphaltene molecules. These molecules are complex with long side chains exhibiting the high molecular weight of the bitumen hydrocarbon molecules and the great tendency to coke as noted by high MCR (micro-carbon residue) numbers.

In addition, these long side chains readily entangle with other similar molecules to make large unmanageable sticky clumps. Adding direct, intense, instantaneous heat to these sticky clumps generates substantial quantities of coke and light gases. Rapid cooling creates condensation reactions generating differently configured complex asphaltenes with long side chains that are just as difficult to deal with further downstream in the processing.

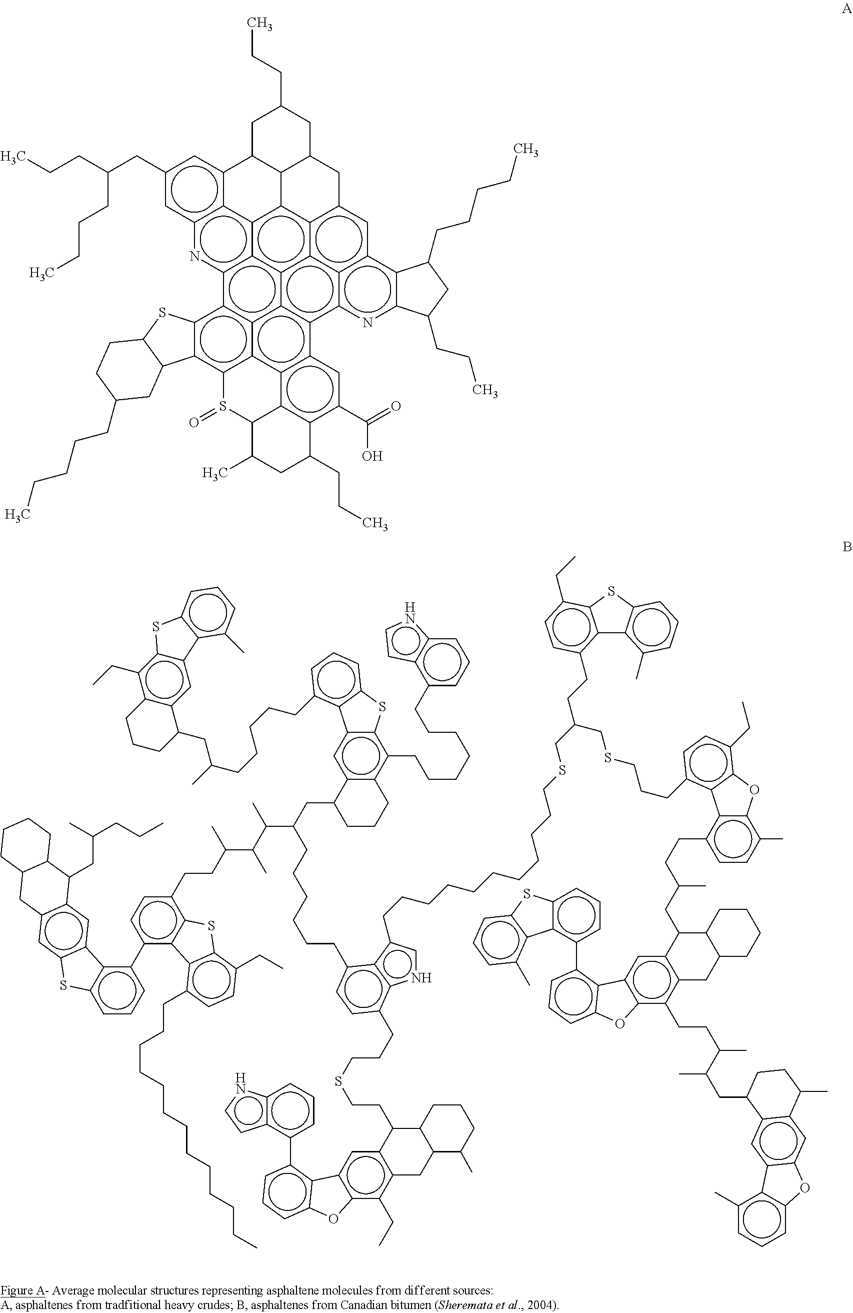

A controlled mild thermal cracker creates a thermally-affected asphaltene that cleaves the long side chains of the bitumen molecules in such a fashion that retains the molecules' core structure, which resembles an inert coke particle. The resins, which normally solubilize the asphaltenes, are also thermally affected, resulting in a reduction of asphaltene solubility, enabling precipitation. Once precipitated, the particles of these modified asphaltenes remain solid at elevated temperatures. The cleaved side chains when separated become primarily light hydrocarbon liquid molecules which when captured may increase the overall economic yield of pipeline ready crude.

In U.S. Pat. No. 4,454,023 a process for the treatment of heavy viscous hydrocarbon oil is disclosed, the process comprising the steps of: visbreaking the oil; fractionating the visbroken oil; solvent deasphalting the non-distilled portion of the visbroken oil in a two-stage deasphalting process to produce separate asphaltene, resin, and deasphalted oil fractions; mixing the deasphalted oil fractions (“DAO”) with the visbroken distillates; and recycling and combining resins from the deasphalting step with the feedstock initially delivered to the visbreaker. The U.S. Pat. No. 4,454,023 patent provides a means for upgrading lighter hydrocarbons (API gravity>15) than Canadian Bitumen but is burdened if used with Canadian Bitumen by the misapplication of thermal cracking that will over-crack and coke the hydrocarbon stream, as well as by the complexity and cost of an additional solvent extraction stage to separate the resin fraction from the DAO. Recycling part of the resin stream is required to produce a product which meets pipeline transportation specifications and increases the operating costs and complexity and process intensity of the operation.

Typical thermal crackers, like visbreakers, do not appreciably improve the characteristics of the complex Canadian Bitumen asphaltene molecules. At elevated temperatures, the asphaltene molecules will become liquid and are highly sticky.

When these typical visbreakers are integrated with SDA processes, the solvent in the liquid phase from the SDA process is typically used to transport these separated asphaltenes, as a slurry to the byproduct processing operation (gasification, spray drier, or asphalt plant).

In U.S. Patent application 2007/0125686, a process is disclosed where a heavy hydrocarbon stream is first separated into various fractions via distillation with the heavy component sent to a mild thermal cracker (visbreaker). The remaining heavy liquid from the mild thermal cracker is solvent deasphalted in an open art SDA unit. The asphaltenes separated from the SDA are used as feed to a gasifier. The resulting deasphalted oil is blended with the condensed mild thermal cracker vapour to form a blended product. Standard visbreaking faces the challenges of early coke generation without impacting the characteristics of the asphaltenes. The asphaltenes are mixed with the SDA solvent and sent to a gasifier as a liquid slurry. The high-cost solvent is consumed in the gasifier, increasing the capital and operating cost of the entire operation while also increasing the carbon footprint of the process and the process intensity.

### Static Mixers and Primary Bitumen Processing in the Prior Art:

Refining industry practice uses static mixers to mix two streams, typically a light hydrocarbon stream and a heavy hydrocarbon stream. Static mixers are useful when the two streams have similar viscosities and the flow regime is in the turbulent region. When viscosities of the streams differ by factors of greater than 1000, static mixers do a poor job of mixing the streams. In addition, for processes with a stream or streams having a high propensity to foul, such as a modified-asphaltene stream, static mixers create a flow restriction point, added surface area and irregular wall features exposed to the stream, and increase the probability of fouling.

Static mixers have been used to attempt to mix solvent and crude to enhance a deasphalting process in an asphalt extractor. However, due to the large viscosity differences between the heavy crude and solvent (well over a factor of 1000 difference), a static mixer in this application does not provide any noticeable benefit.

### Rotary Shear Mixing Devices in Crude Refining/Oil Sands Upgrading Processes in the Prior Art:

High shear mixers have been considered in crude refining applications to improve the flow properties of the crude. In US Patent Application 2011/0028573, a shear mixer is used to attempt to increase the API gravity of a crude oil, by introducing the crude oil to a light gas within a high shear mixing device. The high shear forces essentially “entrain” the gas into the crude. After a nominal settling time, the gas will liberate from the crude especially under warmer temperatures, thus impacting RVP (Reid vapour pressure) on the crude thereby limiting the benefit of this application of shear mixing in crude refining and with a resulting increase in a two-phase fluid which is unsuitable for pipeline transport and pumping. This application though does demonstrate the ability to thoroughly mix two different phases of material with dissimilar relative densities (and viscosities).

In the Canadian Oil Sands, vessels with rotating disks have been used in studies to determine the dissolution rate of bitumen into organic solvents. R. Ulrich et al (Application of the Rotating Disk Method to the Study of Bitumen Dissolution into Organic Solvents, Canadian Journal of Chemical Engineering, Volume 69, August 1991) discovered that as the degree of shear increased from the rotating disk the less sensitive the bitumen dissolution was to solvent type. This learning has been applied to open-art commercial SDA units by Foster Wheeler (U.S. Pat. No. 4,088,540) in their commercial asphalt extractors, however, the moving mechanical device is a reliability concern especially when dealing with a precipitated solid asphaltene from Canadian Bitumen. Their objective is to produce light liquid and a heavy liquid hydrocarbon product streams by mixing. The precipitated asphaltenes easily foul the rotating disks in the Foster Wheeler process within the extractor vessel.

### DESCRIPTION OF DRAWINGS

FIG. 1 depicts an illustrative SDA process with a Mixing Enabled Precipitator (MEP) included to improve solvent deasphalting with an inertial separator to enhance solid asphaltene segregation, according to one or more embodiments described.

FIG. 2 depicts a further SDA enhancement on FIG. 1 with a secondary MEP and asphalt extractor arrangement illustrated to improve solvent deasphalting, according to one or more embodiments described.

FIG. 3 depicts an illustrative application of an integrated mild thermal cracking and improved solvent deasphalting process similar to FIG. 2, according to one or more embodiments described.

FIG. 4 depicts an illustrative application of an integrated mild thermal cracking and improved solvent deasphalting process with appropriately placed shear mixing devices within an existing upgrader or refinery with a vacuum and/or coking unit according to one or more embodiments described.

FIG. 5 depicts a specific illustrative application from FIG. 4 of an integrated mild thermal cracking and improved solvent deasphalting process with appropriately placed shear mixing devices fed a vacuum bottoms stream from an existing upgrader or refinery with the various products from the integrated cracker/improved SDA sent to hydrocracking, residual hydrocracking and gasification units according to one or more embodiments described.

FIG. 6 depicts a process intensification of a specific illustrative arrangement for a MEP with a receiving vessel (asphaltene separator) to separate the precipitated solid asphaltenes and the DAO/solvent mixture.

### SUMMARY OF THE INVENTION

It is to be understood that other aspects of the present invention will become readily apparent to those skilled in the art from the following detailed description, wherein various embodiments of the invention are shown and described by way of illustration. As will be realized, the invention is capable for other and different embodiments and its several details are capable of modification in various other respects, all without departing from the spirit and scope of the present invention. Accordingly the drawings and detailed description are to be regarded as illustrative in nature and not as restrictive.

A Mixing Enabled Precipitator (MEP) in one embodiment supports a continuous process to completely and rapidly mix two different viscosity fluids with the magnitude of viscosity difference being at least 100,000. The MEP of an embodiment provides enhanced mass transfer to accelerate precipitation of solid asphaltenes by changing the solubility characteristics of the asphaltene particles in the blended stream from the heavy hydrocarbon stream for downstream separation.

The MEP in an embodiment provides nearly instantaneous precipitation with the mixing and enhances mass transfer by disentangling hydrocarbon chains. The device may change the characteristics of the asphaltene molecule by cleaving side chains of Canadian bitumen molecules and producing additional viable hydrocarbon product. The solids precipitated in an embodiment of the MEP and transported out of the device may be in the 10 μm to 900 μm range. The MEP may operate in a preferred embodiment, optimally in the shear number range of 3 to 40.

An open art SDA scheme may be modified in another embodiment to include appropriately placed mixing-enabled precipitators (MEP's) to reduce solvent use requirements in an asphaltene separation step and increase overall reliability for SDA processes, particularly suitable for Canadian Bitumen. When integrated with a mild thermal cracker, an improved SDA configuration of this embodiment may further improve crude yield for oil producers looking to produce pipeline-ready crude without the additional diluent and for refiners/upgraders wishing to debottleneck existing facilities such as residue hydrocrackers and coking units.

### DETAILED DESCRIPTION OF VARIOUS EMBODIMENTS

The detailed description set forth below in connection with the appended drawings is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details.

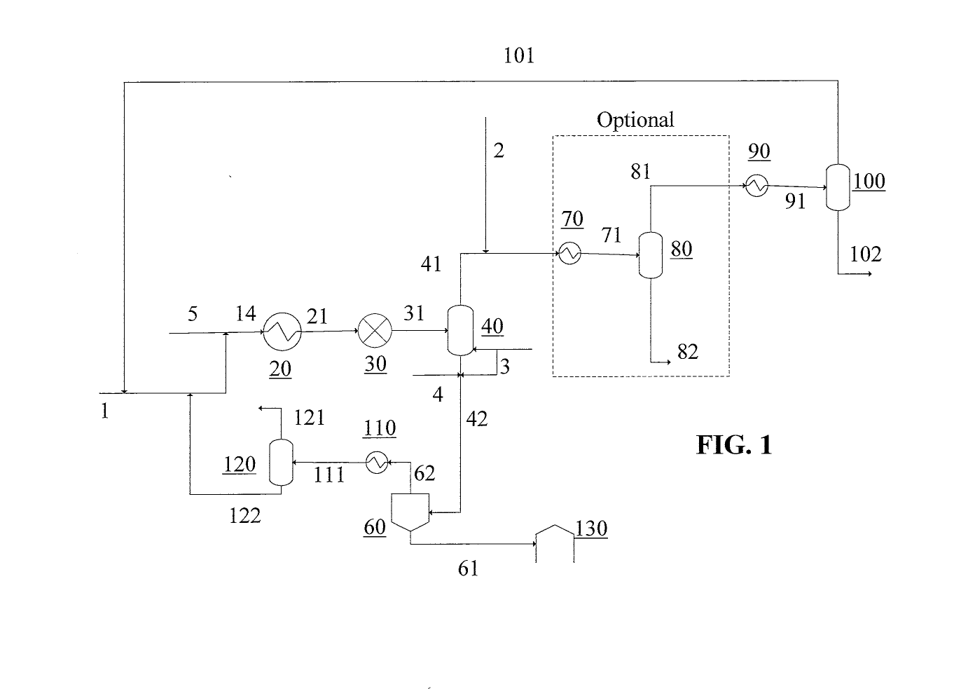

FIG. 1 is a process flow diagram depicting an improved SDA process, using an open-art SDA process with addition of a Mixing Enable Precipitator (MEP) 30, applied to a heavy hydrocarbon (ex. Canadian Bitumen) stream 5 to effect mixing with a solvent to create a blended hydrocarbon suitable as refinery and pipeline feed from various combinations of product streams 82, 100 and 102.

Fresh solvent make-up is added in a stream, 1, and recycled solvent from the process through other streams 101 and 122. The mixed stream 14 is heated to an appropriate temperature (275-400° F. range) and sent through a MEP 30. With such large differences in viscosity between the asphaltene-rich stream and the solvent (light hydrocarbons like butane through to heptane), static mixers have proven not to provide adequate mixing and thus additional solvent is required to force mixing in the absence of MEP or active mixing devices. However, after a certain point of adding more solvent, the two liquids (solvent and asphaltene-rich stream) will exhibit stratification in the transport piping thus limiting any premixing of the liquids in the piping prior to the asphalt extractor/separator. Theoretically, the open area of a static mixer can be reduced to improve mixing, but in practice, plugging of the reduced open area mixer results when dealing with the asphaltene-rich stream.

Rapid/Complete (ex. High Shear) Mixing and primary Bitumen Processing:

Nothing in the prior art of primary heavy crude (ex. Canadian Bitumen) processing involves the use of rapid/complete (ex. high shear) mixing directly upstream of a solvent deasphalting unit. In addition, precipitation of asphaltenes directly to the solid form has be avoided by prior designs as being an undesirable result. Application of rapid/complete mixing in the petroleum industry has heretofore focused on the initial extraction of bitumen from the sand, and on processing oilsands tailings (a reclamation process stream as noted in the following patents, U.S. Pat. No. 7,758,746, U.S. Pat. No. 7,867,385, U.S. Pat. No. 7,585,407 among others).

A MEP 30, has been applied by the Applicants to a pilot plant in the service of deasphalting to improve the mixing of the two involved highly different viscosity liquid (asphaltene-rich and light hydrocarbon solvent) to promote solids precipitation.

This novel application of rapid/complete mixing can provide the following benefits, which it is thought to arise through either/both:
1. Creating intimate contact between solvent and oil resulting in:
   a. Reduced S/O ratio to meet same yield/quality of products reducing operating costs.
   b. Reduce equipment size by reducing residence time to meet the same yield/quality of products at a constant S/O ratio.
   c. Remove need for any mass transfer and/or mixing internals within the asphalt extractor thus improving reliability economically for the entire process—creating a simple clarifier or asphaltene separator.
   d. Reduced solvent losses.
   e. Promote rapid precipitation of asphaltene solids
2. Increased forces (ex. shear forces) acting on the long-chained, entangled asphaltene molecules, to firstly untangle and separate these molecules and secondly, in theory to break any weak bonds/attractions (polar) that might otherwise hold resins/asphaltenes together to create “larger” asphaltene structures. This may:
   a. Increase liquid DAO/resin yield by better separating the asphaltenes from the DAO/resin creating a solubility change between DAO and asphaltenes.
   b. Increase potential to remove metals that may be held in these larger molecules with minimal/no attraction.
   c. Enhance rapid precipitation of asphaltene solids.

A MEP successfully deals with the challenge of intimately mixing a high viscosity stream (i.e. bitumen) and a low viscosity stream (i.e. low MW hydrocarbon like butane, pentane, hexane or heptane or a mixture) of solvent. The rapid/complete mixing produces a standardized and relatively homogenous mixture of ingredients that do not otherwise naturally mix as intimately or thoroughly. It is thought that high shear (turbulence) acts to keep the solubility driving force high for mass transfer: As turbulence increases, mass transfer improves, and complete mixing is approached. With the achievement of instantaneous mixing, the desired rapid precipitation of asphaltenes from the bitumen and light solvent results.

As an example of accomplishing the desired mix, MEP's can be applied to generate rapid/complete mixing to promote the necessary turbulence. There are a variety of methods to generate shear force. Below is an example of a preferred embodiment of a high shear mixing device with provision for handling solid precipitation within the device. The device may utilize a rotor and a stationary stator typically operating at considerably high rotational speeds to produce high rotor tip speeds. Multiple rotors and stators with varying degrees of shear generation can be applied. The differential speed between the rotor and the stator imparts extremely high shear and turbulent energy in the gap between the rotor and stator. Therefore, rotor tip speed is an important factor when predicting the amount of shear input into the mixing of the two streams. Rotor tip speed, a function of rotor diameter and rotational speed, can be represented by equation (1)

$$V = π D n ( in \frac{m}{s} ) \qquad ( 1 )$$

where D is the diameter of the rotor in metres, and n is the rotational speed of the rotor in rpm. Equation 1 indicates the relation of the rotor size and the rate at which it rotates. Rotor tip speed is in [units]. If multiple rotor blades are deployed, this measure is the sum of tip speed of all blades.

Additionally, the gap distance between the rotor and the stator will contribute to the amount of shear. The equation that is used for calculating the shear in the gap between rotor and stator is noted in (2):

$${S}_{r} = \frac{V}{g} ( {s}^{- 1} ) \qquad ( 2 )$$

where Sᵣ is the shear rate, and g is the gap between the rotor and stator in metres. The shear rate is typically used to describe the performance of a high shear mixer. Where multiple rotor tips (blades) are involved, this fact is already considered in the calculation of V (tip speed) in equation 1.

Another important factor is the shear frequency, fₛ, or the number of occurrences that rotor and stator openings mesh.

The shear frequency considers the shear mixer geometry and is given by Equation (3):

$${f}_{s} = {N}_{r} {N}_{s} \frac{n}{60} ( {s}^{- 1} ) \qquad ( 3 )$$

where Nᵣ represents the number of rotor blades and Nₛ represents the number of stator openings.

An empirically useful shear calculation provides the shear number (S) which is a relation of the shear frequency and shear rate (a direct function of tip speed). Equation (4) shows the method of devising a dimensionless Shear number which provides a means for comparing shear effects of two (or more) mixing devices.

$$S = \frac{{s}_{r}}{{f}_{s}} \qquad ( 4 )$$

On that basis, it has been determined that shear numbers in the range of 3-40 may be best suited in this application to successfully accomplish the desired instantaneous intimate mixing of asphaltene-rich material and solvent to allow for fast precipitation of solid asphaltenes. In a preferred embodiment, optimal shear numbers are in the 8-14 range. Shear numbers above 50 probably provide a diminishing return on shear generated and benefit obtained (i.e. costs of providing force to the fluid). Those increased shear rates are not commensurate to suitable incremental disentanglement or mixing effects.

When considering rotor-stator designs, there may be multiple stators and rotors, and the shear number must be applied for each rotor in each row.

The MEP needs to generate high shear forces to promote instantaneous and rapid mixing (mass transfer which accelerates asphaltene precipitation) of the two hydrocarbon streams to create the precipitated solid asphaltenes while allowing for continuous transport of the resulting solid/liquid mixture within the device.

The mixing portion of the MEP (typically one or more sets of rotors and stators) must accommodate the precipitation/generation and presence of a large quantity of asphaltene solids within the device. The MEP design must balance the requirement for high shear forces to promote asphaltene precipitation with sufficient opening within the device to allow solids to travel through and out of the device. The exit of the MEP must have a chamber to accept solids generated/precipitated within the device and accommodation or provide pressure differentials which push material in the MEP out to a transport pipe or a settling vessel (asphaltene separator). The chamber can be open or equipped with a volute and/or impeller to promote transport of the solid/liquid mixture out of the MEP.

In a preferred embodiment, the MEP would be able to pass solid particles that range in size from 10 μm up to 900 μm and are suspended in a liquid mixture.

A primary benefit of placing a MEP upstream of a standard asphalt extractor with process internals is that the intimate mixing from the MEP removes the necessity of having static or moving mixing internals within the asphalt extractor. The precipitated solid asphaltenes are highly fouling and thus provisions to remove any restrictions in the system are desirable and reduce process intensity. A simple asphaltene separator can be used instead of an extractor.

Another primary benefit of the rapid/complete MEP device in this application is a reduced S/O ratio over that of a static mixer by at least 30%. This results in smaller separator equipment and less operating cost (i.e. circulating solvent liquid and recovery/make-up facilities) to produce the same yield/quality of products from static mixing. The increased force applied by the rapid/complete MEP device on any remaining co-mingled long and medium chained portions of the asphaltenes may also assist in the solvent being even more intimately mixed with asphaltenes to promote rapid and effective precipitation of asphaltene out of solution. Even after factoring in the added (relatively low) power requirements for the rapid/complete MEP mixing, there is significant savings through the lower solvent to oil ratios achieved, and reduced process intensity.

At these low solvent to oil ratios, after processing in extractor 40, the asphaltenes are considered essentially oil-free and can be removed from the extractor/separator and transported as stream 42 via fluidized gas (similar to conventional transport of coke and coal in other industrial settings) to an inertial separator 60, for separation of solids from any entrained liquid and transport gas to create a dry solid that is easily stored and transported for further processing.

The transfer line, stream 42, is heated to vaporize as much solvent as possible while still keeping the asphaltenes in a solid state, within a range of transport temperatures which is readily found by adjustment in operating but is within a range of 150-300° C. This may depend on the input feedstock and the solvent used.

Additional solvent, as used in the prior art, does not have to be added/wasted as a transportation media in this process. Approximately 4-10 times the solvent needed for the SDA would be needed to transport the solid asphaltenes without plugging in a conventional system.

Also, instead of a device like a spray drier that requires a restriction (nozzle) which will readily plug to promote solid/gas separation an inertial separator 60 with a large open area, and geometry conducive to solid separation from gas and continuous solid flow is provided.

The gas stream 4 is injected at the bottoms outlet of column 4 to promote the flow of the solids. Solvent in stream 3 is added to the extractor to improve DAO extraction. The gas in stream 42 ends up in the inertial separator 60 along with any entrained solvent. The vapour from the inertial separator is cooled in exchanger 110, and separated in a flash drum 120. The recovered liquid solvent stream 122 is mixed with stream 1 for reuse in the process. Stream 121, the fluidized gas is separated and reused.

As in other SDA processes, the extracted DAO from unit 40 is processed further to separate solvent from DAO. Stream 41 has solvent added from stream 2 if necessary and is heated to reduce the solubility of the DAO in the solvent to begin the separation phase. Heater 90, or if a resin product is desired, heater 70, are used to heat stream 41.

Supercritical conditions can be used to separate the solvent from the DAO in unit 100, which typically comprises a solvent extraction column and a low pressure stripper.

Stream 102 is a highly concentrated DAO stream, while stream 101 is solvent that is recycled in the process. If a resin product is desired, a resin extraction unit 190 complete with an extractor column and a low pressure stripper may be employed. Stream 41 is heated and enters unit 80 creating a resin rich stream 82 and a DAO/solvent rich stream 81 to be processed in the solvent extraction unit 100.

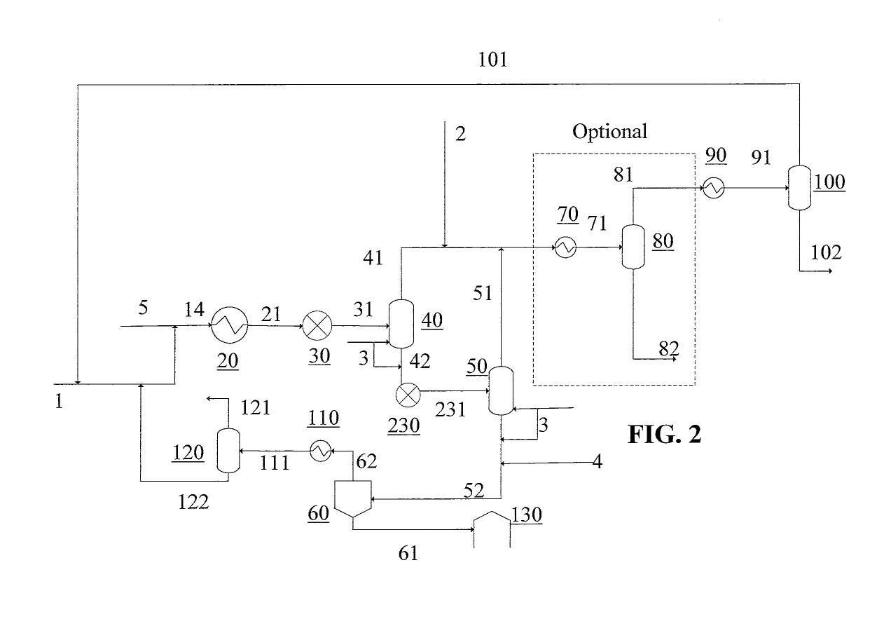

In another aspect, FIG. 2 demonstrates another placement of the MEP to improve DAO extraction, when a secondary asphaltene extractor/settler, unit 50, is used in the SDA process. This second MEP produces the same types of benefits as placing a MEP in front of the primary extractor. Essentially, a MEP can advantageously be coupled with any extraction column designed to separate asphaltenes from DAO, and can be classified in this invention as a asphaltene separator or precipitator/separator.

The secondary asphaltene extractor 50 is employed to increase overall recovery of product hydrocarbon from the process and ensure all oil is removed from stream 42 prior to being sent to the inertial separator 60. In addition, unit 50 reduces overall solvent circulation rates.

Instead of sending stream 42, directly to the secondary asphaltene extractor, it is in this case sent to a MEP 230 to provide enhanced mixing of the asphaltene to allow the solvent to be intimately and rapidly mixed with the asphaltene.

Conventionally, and in common current practice, additional solvent extraction is performed on the primary deasphalted oil in the form of a resin extractor 80 to provide a separate deasphalted heavy oil stream 82. This feature is included in the process of this invention as well. As an improvement, the additional solvent extraction step on the asphaltene-rich stream by extractor 50 uses standard liquid-liquid extraction with the same solvent used in the primary extractor 40, and has a MEP 230 included in the design. The placement of this MEP 230 and standard liquid-liquid column arrangement on the asphaltene-rich stream is new and is beneficial, since the solvent to oil ratio can be further decreased within this column to 5:1 (from 10 to 20:1 typically) to increase the recovery of deasphalted oil with the overall solvent use reduced.

Solvent in stream 3 is added to the asphaltene-rich stream 41 to a very high solvent to oil ratio and is cooled further to enhance asphaltene precipitation and thus oil recovery within column 50.

The deasphalted oil stream 51 is sent to the resin extractor 80 to be further refined for product blending.

The bottoms stream from the secondary asphaltene extractor column 50, like the bottoms of column 40, is concentrated asphaltene and becomes stream 52 and is sent via gas in stream 4 to the inertial separator 60 for solids separation, drying and storage.

It is to be noted that the invention can embody either or both MEP mixing devices at either or both locations.

Overall solvent use to achieve high hydrocarbon recovery using the combination of the rapid/complete mixing device 230, and the secondary asphaltene column 50, is about 15-30% less than when using a static mixer in the process. The result is a significant reduction in energy consumption compared to a state of the prior art 3-stage extraction process. This high performance solvent extraction scheme, including the MEP 230 and column 50 can be applied to an existing open-art solvent extraction scheme in operation to further increase crude yield and/or reduce operating costs by reducing total solvent circulation. In another aspect, the new scheme can be used as an improvement to designs in heavy oil recovery that would normally use prior art solvent deasphalting.

As in FIG. 1, the deasphalted oil in stream 41 is mixed with a similar solvent, if necessary, and the temperature is raised by heat exchanger 70 to precipitate out any resins and remaining entrained asphaltenes in unit 80 the resin extractor. The bottoms from the resin extractor are blended with the final product, while stream 81 is further heated in exchanger 90, and sent to solvent recovery 120. The solvent recovery unit 120 is typically run as a supercritical extractor to reduce operating costs, with a stripper provided on the deasphalted oil to reduce solvent losses to below 1%. The recovered solvent stream 101 is recycled to the front of the process for re-use, while stream 102 is blended with streams 12 and 82 for use as product.

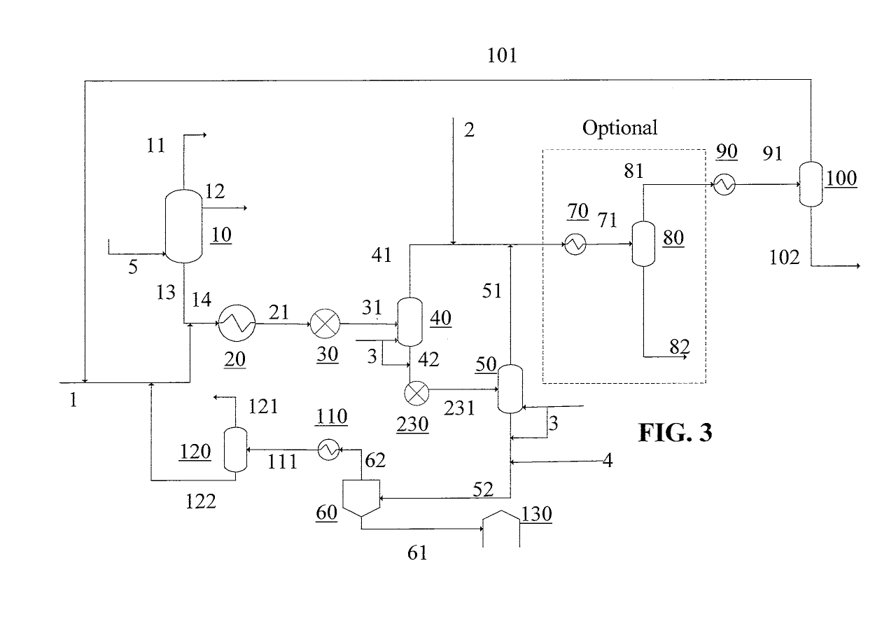

An advantageous application of the enhanced SDA scheme noted in both FIGS. 1 and 2 is the integration of this SDA configuration with a conventional mild thermal cracker of the prior art which is illustrated in FIG. 3. A preferred embodiment is integrating the thermal cracker in U.S. Pat. No. 7,976,695 with the MEP/separator configuration in this invention.

Through pilot testing of the concept, it was demonstrated that the thermally-affected asphaltenes recombined together to create higher molecular weight asphaltenes. The asphaltene molecules range in size from 5 um to 500 um, are thermally stable, remain a solid at elevated temperatures, can be physically compared to inert coke particles and are readily separated from the oil in the presence of a modest amount of solvent. The application of the MEP 30 and/or 230 may act to untangle any asphaltene particles physically combined to allow for easier solvent separation.

The impact of unit 10 and 30 on stream 13 is the need for a very simple separation in the asphalt extractor (asphaltene separator now) 40. The amount of solvent required in stream 1 to mix with stream 13 is far less than what is required in industrial applications for bitumen (8-9:1 by mass), approximately in the 2-4:1 solvent to oil ratio range. The solvent may be C4-C9, or an appropriate mixture. The extractor creates a deasphalted oil stream 41 and an increasingly concentrated solid, stable and non-sticky asphaltene-rich stream 42.

As noted in table 1, this integrated process provides higher yields than other traditionally arranged upgrading processes. Along with this product benefit, the capital cost reductions from using an inertial separator 60, and the operating cost savings from the generated thermally affected asphaltenes by reactor 10, the MEP's 30 and/or 230, and secondary asphaltene extraction column 50, make this a valuable tool to increase refiners' and upgraders' long-term profits and sustainability.

TABLE 1
Product yield comparison

| | Volume % | Mass % |
|---|---|---|
| Coking | 80-84 | 78-80 |
| Standard reactor/solvent | 86 | 80-82 |
| extraction process | | |
| FIG. 3 process | >89 | 84-86 |

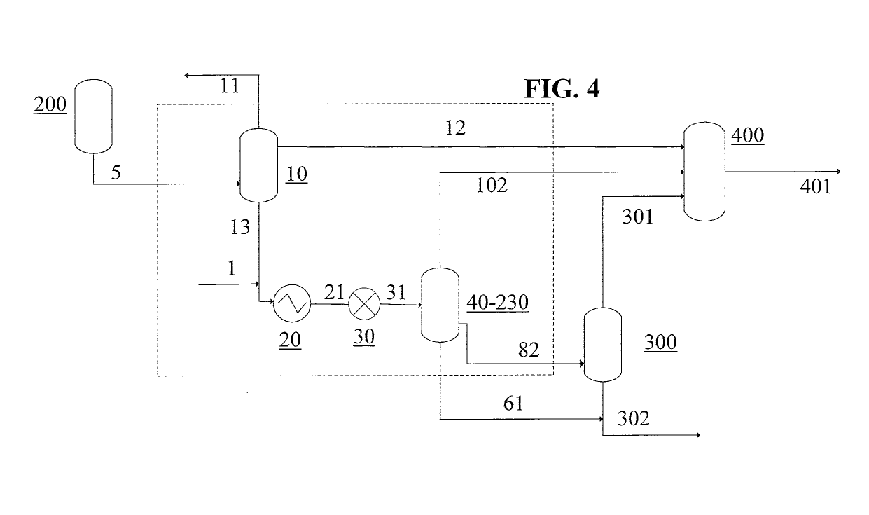

In addition to applications of this invention in new greenfield plant design opportunities, FIG. 4 shows an illustrative application of the integrated controlled thermal cracker and improved SDA with MEPs. The proposed integrated process, reactor 10, and improved SDA with appropriately placed MEPs (30 and/or 230 as necessary), and asphaltene recovery, items 20-120, can be placed upstream of a refiner's/upgrader's coking unit. The benefit to a refiner/upgrader is the ability to debottleneck existing vacuum and coking facilities and accept more heavy crude to the unit. More barrels processed on existing equipment equates to larger profits and economic returns for similar capital costs. In addition, with a higher quality material being sent to the coking unit 300, the operating severity can be decreased, increasing the life of the coker by increasing the cycle time for the coker (from 12 to 24 hours), and producing less gas and coke and more high value product. Capital costs to replace equipment can be delayed and an increased yield can be realized (approx. 2-3%). Solid asphaltenes captured in the SDA have a readily available disposition, stream 302, the existing coke gathering and transport systems, making the addition of the proposed integrated process more cost effective and highly profitable. Process intensity may be decreased.

As well, and by example, stream 5 can be the bottoms streams from an atmospheric column, vacuum column, or a catalytic cracking unit, generally referred to as unit 200 in FIG. 4. The integrated cracker and SDA process produces a DAO stream 102, that can be further processed into a transportation fuels stream 401 in a hydrocracking and hydrotreating complex unit 400. The integrated cracker and SDA process with MEP also can produce a resin quality stream 82 that can be sent to a coking, FCC (fluidized catalytic cracking) and/or an asphalt plant for further processing into finished products. Solid asphaltenes generated as stream 61 can either be mixed with coke generated in unit 300 or sent off-site for further processing (energy generation and/or sequestration).

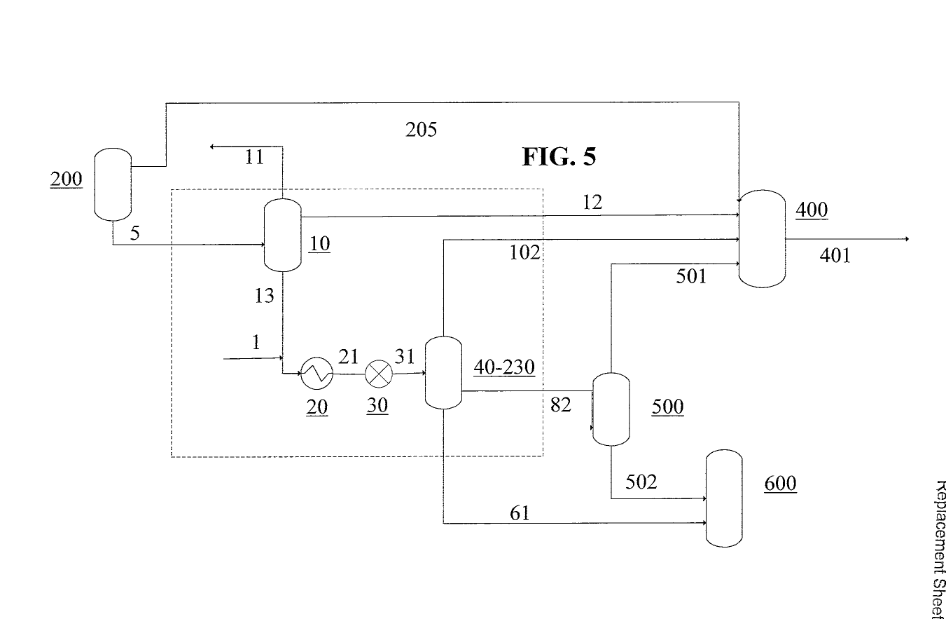

As yet another example, FIG. 5 shows a specific embodiment for a new design or revamp opportunity for a refinery and/or upgrader. Unit 200 is a vacuum unit and the bottoms stream 5 is sent to the integrated cracker/SDA process units 20-120 with appropriately placed MEPs 30 and/or 230. The DAO stream 102, is sent to the hydrocracking and hydrotreating unit 400, along with stream 205 from the vacuum unit. A resin stream 82 is produced from units 20-120 and sent to a residue hydrocracking unit 500. With less asphaltenes, that are highly exothermic when reacted, sent to unit 500, the residue hydrocracker can run at higher conversion rates producing more material as final transportation fuel product. The solid asphaltene stream 61 from units 20-120 can be sent to the gasification unit for hydrogen generation.

As in FIG. 4, the benefits of adding the integrated unit in FIG. 5 can include:

1. Maximum yield of incoming crude to plant

2. Debottlenecking, if existing, or reduction of coking unit size

3. Debottlenecking, if existing, or reduction of residue hydrocracking size

4. Debottlenecking, if existing, or reduction of gasification unit size

5. Overall carbon footprint reduced for process facility.

6. Process intensity decreases (gains in overall efficiencies and economics)

The integrated process in FIG. 3 can also can help sweet, low complexity (hydro-skimming) refiners accept heavier, cheaper crudes which are more readily available, and thus reposition refining assets to capture more value by accepting a broader range of feedstock. The integrated process of this invention can be placed at the front of the refinery to provide the initial conditioning of the heavier crude.

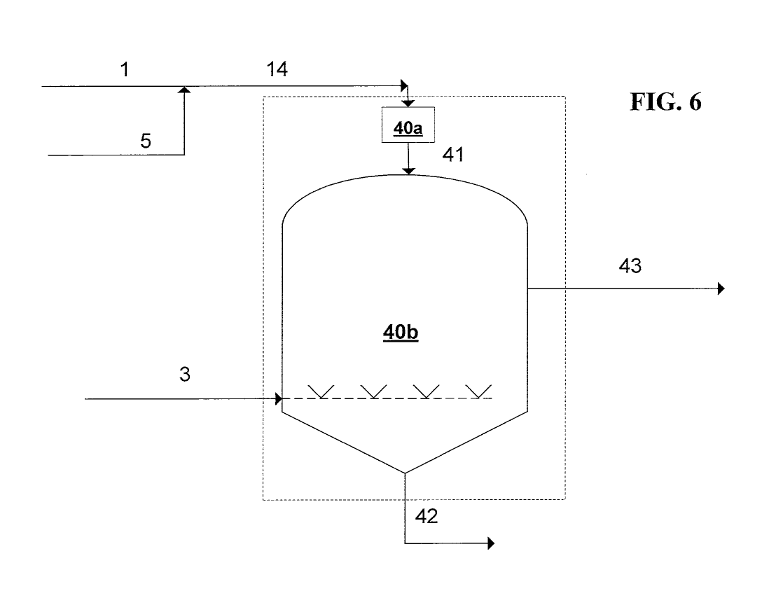

FIG. 6—illustrates a preferred arrangement for the MEP (40a) and the asphalt separator (40b). The two units are considered one operation within the dotted lines with 40a and 40b typically separated by a relatively short transport pipe. The complete and intimate mixing in the MEP provides desired precipitation of the solid asphaltene particles resulting in stream 41 which is a two phase solid/liquid mixture. The downward discharge from the MEP, taking advantage of Stokes' Law, enters a clarifying vessel 40b to allow settling of downward flowing asphaltenes. The MEP (40a) and separator (40b) can be closely coupled or separated by an appropriate distance based on processing and plot plan requirements. In a preferred embodiment, 40a and 40b are classified as one unit with the MEP discharging directly into a settling vessel which can be referred to as a clarifier or asphaltene separator.

Within the separator (40b), an asphaltene washing zone can be created by injecting solvent into the bottom portion of the vessel as indicated by stream 3. The solvent/DAO mixture leaves via stream 43 with solid asphaltenes leaving via stream 42. The merging of the two units may greatly increase the reliability of the entire process by reducing the amount of transport piping that could foul or plug. In addition, this simplified arrangement reduces the size of the overall equipment (lower capital cost) and reduces the overall solvent usage (lower operating cost), providing reduced process complexity.

As a further opportunity for process intensification, the MEP can be a high-shear mixing pump that includes pressure generation while performing rapid/complete mixing. The need for separate pump devices may be removed if a high-shear mixing pump MEP is located in an appropriate spot in the process, thereby potentially reducing capital cost and further simplifying the process.

The mixing-enabled precipitation can be used in other industries from stream lab analysis to any process involving asphaltene processing (i.e. asphalt plant operation).

### DEFINITIONS

The following terms are used in this document with the following meanings. This section is meant to aid in clarifying the applicant's intended meaning.

A slurry is, in general, a thick suspension of solids in a liquid.

In chemistry, a suspension is a heterogeneous fluid containing solid particles that are sufficiently large for sedimentation. Suspensions are classified on the basis of the dispersed phase and the dispersion medium, where the former is essentially solid while the latter may either be a solid, a liquid, or a gas.

In chemistry, a solution is a homogeneous mixture composed of only one phase. In such a mixture, a solute is dissolved in another substance, known as a solvent.

An emulsion is a mixture of small globules of one liquid into a second liquid with which the first will not dissolve.

Precipitation is the process of separating a substance from a solution as a solid

Pneumatics is a branch of technology, which deals with the study and application of use of pressurized fluids to effect mechanical motion.

Process intensification is the replacement or combination of separate operating units into one unit improving the overall performance of the process. Similarly, process intensity expresses a relative concept for comparing a combination of complexity, capital intensity and operational expense factors for processes or facilities.

Canadian Bitumen is a form of petroleum that exists in the semi-solid or solid phase in natural deposits. Bitumen is a thick, sticky form of crude oil, having a viscosity greater than 10,000 centipoises under reservoir conditions, an API gravity of less than 10° API and typically contains over 15 wt % asphaltenes.

What is claimed:

1. A Mixing Enabled Precipitator (MEP) supporting a continuous process to completely and rapidly mix a heavy hydrocarbon stream with a light hydrocarbon stream for enhanced mass transfer to accelerate precipitation of solid asphaltenes by changing the solubility characteristics of asphaltene particles from the heavy hydrocarbon stream in a resulting blended stream for downstream separation.

2. The device of claim 1 where the precipitation is nearly instantaneous with the mixing.

3. The device of claim 1 which enhances mass transfer by disentangling hydrocarbon chains.

4. The device of claim 1 which changes the characteristics of asphaltene molecules by cleaving side chains of included Canadian bitumen molecules producing additional viable hydrocarbon product.

5. The device of claim 1 which enhances mass transfer by intimately mixing two different fluids with comparative viscosity difference of at least 100,000:1.

6. The device of claim 1 where solids precipitated in the MEP and transported out of the device are in the 10 μm to 900 μm range.

7. The device of claim 1 with a shear number in the range of 3-40.

8. A Mixing Enabled Precipitator (MEP) placed upstream of a secondary asphaltene extractor supporting a continuous process to completely and rapidly mix a heavy hydrocarbon stream with a light hydrocarbon stream for enhanced mass transfer to accelerate precipitation of solid asphaltenes by changing the solubility characteristics of asphaltene particles from the heavy hydrocarbon stream in the resulting blended stream for downstream separation.

9. The device of claim 8 where the precipitation is nearly instantaneous with the mixing.

10. The device of claim 8 which enhances mass transfer by disentangling hydrocarbon chains.

11. The device of claim 8 which changes the characteristics of asphaltene molecule by cleaving side chains of Canadian bitumen molecules it processes, producing additional viable hydrocarbon product.

12. The device of claim 8 which enhances mass transfer by intimately mixing two different fluids with comparative viscosity differences of at least 100,000:1.

13. The device of claim 8 where solids precipitated in the MEP and transported out of the device are in the 10 μm to 900 μm range.

14. The device of claim 8 with a shear number is in the range of 3-40

15. A Mixing Enabled Precipitator (MEP) placed upstream of a mild thermal cracker to improve the performance of the thermal cracker and increase the yield of bitumen processing supporting a continuous process to completely and rapidly mix a heavy hydrocarbon stream with a light hydrocarbon stream for enhanced mass transfer to accelerate precipitation of solid asphaltenes by changing the solubility characteristics of the asphaltene particles in the blended stream from the heavy hydrocarbon stream for downstream separation.

16. The device of claim 15 which provides a homogenized fluid feedstock with untangled asphaltene molecules to improve uniform heat flux for all molecules.

17. The device of claim 15 which changes the characteristics of the asphaltene molecule by cleaving side chains of Canadian bitumen molecules producing additional viable hydrocarbon product.

18. The device of claim 15 where the shear number is in the range of 1-30.

19. A process for producing a pipeline-ready or refinery-ready feedstock from heavy, asphaltene-rich oil or crude oil feedstock comprising the use of a Mixing Enabled Precipitator (MEP) supporting a continuous process to completely and rapidly mix a heavy hydrocarbon stream with a light hydrocarbon stream for enhanced mass transfer to accelerate precipitation of solid asphaltenes by changing the solubility characteristics of asphaltene particles from the heavy hydrocarbon stream in a resulting blended stream for downstream separation.

20. The process of claim 19, where the MEP is placed upstream of a secondary asphaltene extractor.

21. The process of claim 19, where the MEP is placed upstream of a mild thermal cracker to improve the performance of the mild thermal cracker and increase the yield of bitumen processing.

22. The process of claim 19, where the MEP is integrated with a mild thermal cracker, the mild thermal cracker being placed upstream of an SDA process.

23. The process of claim 19 where the solid asphaltenes produced remain a solid until combustion temperatures are reached.

24. The process of claim 19, where the yield of deasphalted oil fractions (DAO) is at least 88% of the feedstock by volume.

25. The process of claim 22, where the SDA process uses a solvent and has: a solvent to oil ratio on a mass balance below 6:1; an operating temperature of 40 to 130° C. below the critical temperature of the solvent; and an operating pressure of 40 to 240 psig below the critical pressure of the solvent.

26. The process of claim 25, where the solvent is C4-C9 hydrocarbons or a mixture of C4-C9 hydrocarbons.

27. The process of claim 19 where the precipitation is nearly instantaneous with the mixing.

28. The process of claim 19 where the mass transfer is enhanced by disentangling hydrocarbon chains.

29. The process of claim 19 where the characteristics of the asphaltene molecule is changed by cleaving side chains of Canadian bitumen molecules that are being processed, producing additional viable hydrocarbon product.

30. The process of claim 19 where the mass transfer is enhanced by intimately mixing two different fluids with comparative viscosity differences of at least 100,000:1.

31. The process of claim 19 where solids precipitated in the MEP and transported out of the MEP are in the 10 μm to 900 μm range.

32. The process of claim 19 where a shear number is in the range of 3-40.

33. The process of claim 22, where the MEP is added to an existing coker-based bitumen Upgrader or refinery to increase overall yields of crude feed and to improve life-cycle of existing equipment.

34. The process of claim 22, where the MEP is added to an existing residue hydrocracking and coker-based bitumen Upgrader or refinery to increase overall yields of crude feed and to improve life-cycle of existing equipment.

35. The process of claim 22, where the MEP is used in a new bitumen Upgrader or existing “sweet crude” refinery in lieu of a coking process to increase yield and quality of crude feeds.

36. The device of claim 1 where the mixing-enable precipitator can be a mixer, or a pump/mixer combination, generating both pressure for the process and mixing the liquids into a homogenized fluid.

37. The device of claim 36 that can accommodate solids, in the range of 10 μm to 900 μm, flowing through it.

38. The device of claim 36 that has shear numbers in the range of 3-40 developing sufficient turbulence for instantaneous mixing.

39. The device of claim 36 where at least 1 rotor/stator generator is used.

40. The device of claim 1 where the MEP and asphalt separator are combined into one operating unit (MEP plus asphaltene separator) for precipitating and separating the precipitated asphaltenes creating a deasphalted oil/solvent mixture and a dry solid asphaltene product.

41. The device of claim 40 where the MEP and the asphalt separator are close coupled

42. The device of claim 40 where the MEP and the asphalt separator are separated by a pipe of at least a fraction of an inch to a length suitable in a commercial operating unit.
